(19) United States
(12) Patent Application Publication
(10) Pub. No.: US 2010/0019637 A1
(43) Pub. Date: Jan. 28, 2010

(54) TELESCOPIC EXTENSION

(75) Inventor: Marc-Oliver Güttinger, Herbrechtingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/517,439

(22) PCT Filed: Nov. 22, 2007
(86) PCT No.: PCT/EP07/62717

§ 371 Date: Jun. 3, 2009

(30) Foreign Application Priority Data
Dec. 22, 2006 (DE) 10 2006 061 096.2

(51) Int. Cl. A47B 88/08; F16C 29/02

(52) U.S. Cl. 312/334.5; 384/26; 384/35

(57) ABSTRACT

A telescopic extension is provided that includes at least one pair of rails consisting of an outer rail defining a groove and an inner rail that can longitudinally move in relation to the outer rail and is guided in the groove. An open gap is located between a region of the outer rail forming a lateral wall of the groove and the inner rail. A channel extending below the clearance gap is connected to one of the rails.

The present invention relates to a telescopic extension comprising at least one pair of rails consisting of an outer rail defining a groove and an inner rail that can move longitudinally in relation to the outer rail and is guided in the groove of the outer rail. Telescopic extensions of this type are used for example in domestic appliances having an internal space, in order to guide the movements of a component within said internal space. This type of telescopic extension is used for example as the movable support of a pullout container in a refrigerator or freezer, or of a crockery basket in a dishwasher, or of a baking tray or grill in an oven.

Generally, in a telescopic extension of this type an open gap is located between a region of the outer rail forming a lateral wall of the groove, and the inner rail. Movement of the rails against one another can lead to the formation of wear debris which can fall out of said gap, or lubricants inserted between the rails can leak out, all of which can be unwanted, particularly in the case of a domestic appliance which may contain foodstuffs, such as a refrigeration unit or an oven. There is the further possibility that dirt or leftover food finds its way between the rails where it becomes abraded; the leftovers then fall out through the gap as just described, which is equally annoying for a user.

The object of the present invention is to create a telescopic extension of the type described in the introduction, from which an uncontrolled escape of contamination can be prevented with little effort.

This object is achieved in that a channel is connected to one of the rails and extends below the gap in order to catch any contamination falling from it.

Rolling elements that move longitudinally are preferably arranged in the gap in order to ensure that the rails move gently against one another.

To ensure that the telescopic extension has a great freedom of movement which is preferably greater that the length of its rails, a second pair of rails comprising two rails moving longitudinally in relation to one another is preferably provided, one of the rails of the first pair of rails being firmly connected to one of the rails of the second pair.

In the main the second pair of rails can be made in exactly the same way as the first, consisting of an outer rail defining a groove and an inner rail that engages in the groove and can move longitudinally in relation to the outer rail, an open gap being located between them. The channel then preferably extends below the gaps in both pairs of rails.

To provide protection against contamination falling from the telescopic extension even when it is in the extended state, a second channel is advantageously provided and can be connected to the other rail of the first pair of rails or to one of the rails of the second pair of rails.

In the case of a telescopic extension consisting of two pairs of rails, a region of the outer rail of the second pair of rails forming a lateral wall of the groove can also extend under the first pair of rails to form the channel.

The channel can be gripped between one of the rails and a lateral wall to which said rail is fastened. In this case a channel section which engages between said one rail and the wall is preferably elastically compressible in order to provide the channel with play-free grip despite any possible broadening of the clearance between the rail and the wall receiving said section.

The channel can also be latched onto the outer rail.

The invention furthermore relates to a domestic appliance in the form of a cabinet having an internal space in which the movements of a component are guided by a telescopic extension in the manner defined above.

Further features and advantages of the invention will emerge from the description of exemplary embodiments which follows and by reference to the accompanying drawings. These show the following:

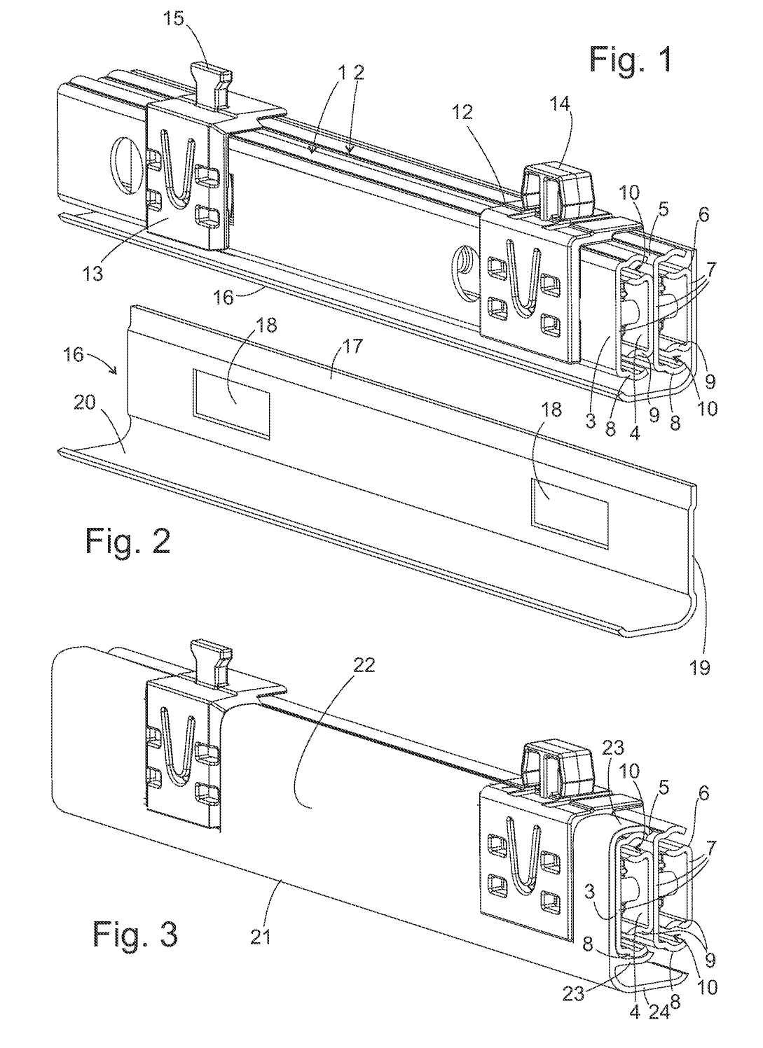

FIG. 1 A perspective view of a telescopic extension according to a first embodiment of the invention;

FIG. 2 A profile that is gripped between the rails and the lateral wall in the telescopic extension in FIG. 1;

FIG. 3 A perspective view of a telescopic extension according to a second embodiment of the invention;

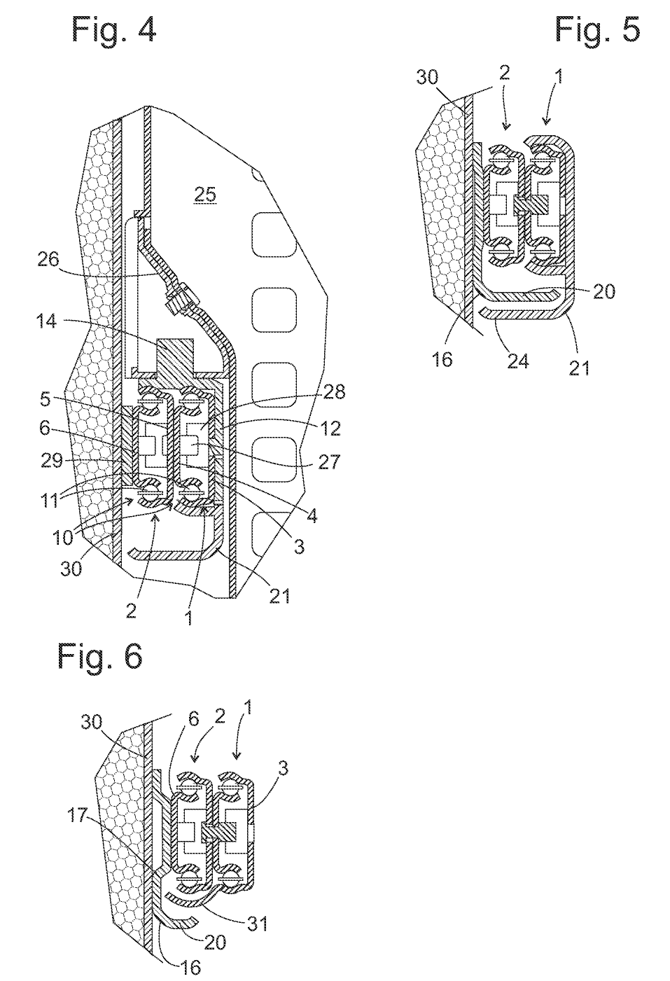

FIG. 4 A section through the telescopic extension in FIG. 2, mounted in a refrigeration unit;

FIG. 5 A section through a telescopic extension according to a third embodiment, combining the features of the first and second embodiment; and

FIG. 6 A section through a telescopic extension according to a fourth embodiment.

The telescopic extension shown in FIG. 1 comprises in a known manner two pairs of rails 1, 2, consisting in each case of an outer rail 3 or 5 and an inner rail 4 or 6, whereby said inner rail engages in and can move within a longitudinal groove of the outer rail 3 or 5. The rails 3, 4, 5, 6 are formed in each case from sheet steel strips and have a mainly level bottom plate 7 which is oriented vertically when the telescopic extension is in its mounting position, together with angled limbs 8, 9 formed from the upper and lower edges of the bottom plate 7. The sides of the limbs 8 facing one another on the outer rails 3, 5 and the limbs 9 of the inner rails 4, 6 are concave, so that in each case the limbs opposite one another form a guide channel 10 that accommodates balls 11 (see for example FIG. 4). The balls 11 guide the rails of a pair relative to one other in a manner that is both free from backlash and frictionless.

Two adapters 12, 13 are latched onto the outer rail 3 of the pair of rails 1. Projecting head pieces 14, 15 of the adapters 12, 13 are used to fasten a component (not shown in FIG. 1) such as a pullout container for a refrigeration unit.

The inner rail 6 of the pair of rails 2 is provided for fastening to a wall, in particular to an inner wall of a refrigeration unit. A plastic profile 16 having an L-shaped or J-shaped cross-section is clamped between said inner wall and the rail 4. This profile 16 is shown on its own in FIG. 2. A vertical limb 17 of the profile 16 has openings 18 through which extend, in the mounted state, fixing materials of the rail 4 or of the wall, so as to fix the bottom plate 7 of the rail 4 at a defined distance from and parallel to the inner wall. The wall thickness of the limb 17 and the curvature of a central section 19 of the limb 17 that contains the openings 18 and projects against the rail 6 are dimensioned so that the central section 19 in the mounted state, as shown in FIG. 1, is flattened between the bottom plate 7 of the rail 4 and the inner wall of the refrigeration unit. This method ensures that the profile 16 is held reasonably firmly despite possible manufacturing tolerances in the distance between the bottom plate 7 and the inner wall of the refrigeration unit.

A horizontal limb 20 of the profile 16 projects from the inner wall of the refrigeration unit and extends beneath the pairs of rails 1, 2. Particles which fall from the guide channels 10 of the pairs of rails are caught by the horizontal limb 20 and so cannot be dispersed about the inside of the refrigeration unit.

FIG. 3 shows in much the same way as FIG. 1 a perspective view of a telescopic extension according to a second embodiment of the invention. The pairs of rails 1, 2 are identical to those shown in FIG. 1. A plastic profile 21 comprises a vertical limb 22 on which are formed two elastic jaws 23 which grasp the limb 8 of the rail 3. A horizontal limb 24 of the profile 21 extends beneath the guide channels 10. This limb 24 is also able to catch particles falling from the channels 10 and to stop said particles from spreading unchecked.

FIG. 4 shows a section through the telescopic extension in FIG. 3, shown here mounted in a refrigeration unit, said section extending along a plane running through the adapter 12 and the head piece 14. A partially shown pullout container 25 formed from perforated metal sheet is screwed to an adapter piece 26 which extends right across the plane of intersection and for its own part is latched onto the head pieces 14, 15. The inward facing bottom plates 7 of the rails 4, 5 are held together by rivets 27 which, together with an elastic buffer 28 fastened to the rail 5, acts as a limiting stop to prevent the rails 4, 5 from parting company. The rail 4 is anchored to the inner wall 30 of the refrigeration unit by means of a spacer 29.

The profile 16 according to FIG. 1 is clamped between the refrigeration unit inner wall and the rail 6, and firmly fixed; it cannot therefore stop particles falling from the guide channels 10 of sections of the rails that are drawn outward from the refrigeration unit. Conversely, the movable profile 21 no longer provides complete protection if it is withdrawn from the internal space of the refrigeration unit along with the rail 3. Preferably, therefore, both profiles 16, 21 are used in combination with one another, as shown in FIG. 5 with the aid of a section through the pairs of rails 1, 2. Here the horizontal limb 24 of the profile 21 runs deeper than the horizontal limb 20 of the profile 16, so that the whole of the telescopic extension has a totally closed, easily cleaned surface on its side facing away from the wall 30.

FIG. 6 shows a fourth embodiment of an inventive telescopic extension in a section similar to those shown in FIGS. 4 and 5. A profile 16 clamped between the inner rail 6 and the inner wall 30 of the refrigeration unit has a vertical limb 17 in much the same way as that shown in FIG. 2, and a horizontal limb 20, the difference being, however, that the width of the limb 20 is reduced in the embodiment shown in FIG. 6, so that said limb extends only beneath the pair of rails 2 adjacent to the wall 30. The lower horizontal limb 8 of the rail 3 belonging to the pair of rails 1 facing away from the wall 30 is broadened by a section 31 extending in the form of a channel beneath the pair of rails 2, said channel being able to catch particles escaping from the guide channels 10 of both pairs of rails 1, 2. The channel-shaped section 31 engages with the profile 16 at a point between the pair of rails 2 and the horizontal limb 20. When the telescopic extension is in its extended state, most of the length of the channel-shaped section 31 is out of the clearance between the pair of rails 1 and the limb 20, and said clearance is then accessible and can be cleaned. At the same time the upper side of the channel-shaped section 31 is laid bare when withdrawn from the refrigeration unit and can likewise be easily cleaned.

1-9. (canceled)

10. A telescopic extension comprising:
a first pair of rails, the first pair of rails including an inner rail and an outer rail, the outer rail having a pair of laterally spaced portions that are spaced laterally from one another and that delimit an inner rail accommodating space therebetween that extends in a longitudinal direction perpendicular to the lateral direction, the inner rail is movable longitudinally relative to the outer rail within the inner rail accommodating space of the outer rail, and the inner rail and one of the laterally spaced portions of the outer rail are laterally spaced from one another such that a clearance gap is delimited therebetween; and
a channel element, the channel element extending beneath the clearance gap and being connected to one of the inner and outer rails.

11. The telescopic extension as claimed in claim 10 and further comprising rolling elements that move longitudinally and that are arranged in the clearance gap.

12. The telescopic extension as claimed in claim 10 and further comprising a second pair of rails including two rails moving longitudinally in relation to one another and one of the rails of the first pair of rails is secured to one of the rails of the second pair of rails.

13. The telescopic extension as claimed in claim 12, wherein one of the two rails of the second pair of rails is an outer rail defining a groove and the other of the two rails of the second pair of rails is an inner rail that engages in the groove and can move longitudinally in relation to the outer rail, a clearance gap is located between the two rails of the second pair of rails, and the channel extends beneath the clearance gaps of both the first and tile second pair of rails.

14. The telescopic extension as claimed in claim 12, wherein one of the two rails of the second pair of rails is an outer rail defining a groove and the other of the two rails of the second pair of rails is an inner rail that engages in the groove and can move longitudinally in relation to the outer rail, and a region of the outer rail of the first pair of rails forms a lateral wall of the inner rail accommodating space and extends beneath the first pair of rails to form the channel.

15. The telescopic extension as claimed in claim 10, wherein the channel is secured between one of the rails and a wall to which the respective rail is fastened.

16. The telescopic extension as claimed in claim 15, wherein a section of the channel between the one rail and the wall is elastically compressible.

17. The telescopic extension as claimed in claim 10, wherein the channel is latched onto the outer rail.

18. A domestic appliance comprising:
a cabinet having an internal space;
a component in the internal space, the cabinet being movable relative to the internal space in a movement guided by a telescopic extension having a first pair of rails, the first pair of rails including an inner rail and an outer rail, the outer rail having a pair of laterally spaced portions that are spaced laterally from one another and that delimit an inner rail accommodating space therebetween that extends in a longitudinal direction perpendicular to the lateral direction, the inner rail is movable longitudinally relative to the outer rail within the inner rail accommodating space of the outer rail, and the inner rail and one of the laterally spaced portions of the outer rail are laterally spaced from one another such that a clearance gap is delimited therebetween, and having a channel element the channel element extending beneath the clearance gap and being connected to one of the inner and outer rails.
